(19) United States
(12) Patent Application Publication
(10) Pub. No.: US 2007/0089688 A1
(43) Pub. Date: Apr. 26, 2007

(54) Apparatus and method for temporary storage of animal waste

(76) Inventors: Christine Nitzsche, Weston, FL (US); Caron D'Ambruso, Austin, TX (US)

Correspondence Address: RICK B. YEAGER, ATTORNEY, 10805 MELLOW LANE, AUSTIN, TX, 78759, US

(21) Appl. No.: 11/506,049

(22) Filed: Aug. 17, 2006

Related U.S. Application Data
(60) Provisional application No. 60/729,494, filed on Oct. 24, 2005.

(51) Int. Cl. A01K 27/00

(52) U.S. Cl. 119/795

(57) ABSTRACT

Sealable feces disposal bags are provided in a temporary storage system. The bags are used to collect animal feces. After feces collection, the bags are temporarily sealed and then taken to a waste storage receptacle. The receptacle houses a bag heat sealer, mechanical sealer, or adhesive sealer which is used to provide an odor-free seal to the bag. Sealed bags are stored on the receptacle until they are removed for garbage pick-up.

### RELATED APPLICATIONS

This application is related to and claims priority from U.S. Provisional patent application No. 60/729,494 filed Oct. 24, 2005.

### FIELD OF THE INVENTION

The current invention relates to devices and methods for disposing of domestic animal waste, particularly dog, cat and other animal feces.

### BACKGROUND OF THE INVENTION—PRIOR ART

There are over 40 million households that own dogs in the United States. Eighty percent of the population lives in urban or suburban areas making the total number households that need to dispose of dog waste approximately 32 million, according to the Humane Society 2003-2004 Survey.

In the past ten years, canine waste removal has been added into the laws of many urban and suburban neighborhoods. Family members now can be seen walking their dogs around their neighborhood with small plastic bags to remove their pet's waste. This bag is then thrown into a trash barrel usually in the garage, to wait until the following week's trash pick-up. Additionally, many urban and suburban homes are zero lot line with small yards making pet excrement in yards unpleasant, due to the odor, mess, and germs, especially for those with small children.

Between trash pick ups, the bag sits in the trash and over time begins to smell, thus making the garage unpleasant over the course of an average week with 10 or more dog waste packages in the trash can. Furthermore, the bags used by conscientious families are generally discarded supermarket bags or newspaper bags made of thin PTFE which do not control odor. In addition to the odor, the bags are an unsanitary solution to a state mandated problem. In addition to the odor, the bags are an unsanitary solution to a state mandated problem. Animal waste contains the same pathogens as human waste, including staph aureus, e-coli and methacillin resistant pathogens.

U.S. Pat. No. 3,575,140 describes an animal refuse container adapted for insertion in a ground cavity so that the top portion thereof is substantially at ground level, including a grate forming a lid for the container and for securing a removable plastic liner therein. A hollow cylinder is mounted on the grate acting as a support for a manually swingable cover plate and as a receptacle for an animal attracting substance. The plastic liner within the container may be partially filled with a deodorizing and waste disintegrating chemical and the liner may be readily removed for disposal purposes.

U.S. Pat. No. 5,551,569 describes a bag dispenser and temporary pet waste receptacle comprising a plastic bag dispenser and waste receptacle for use in the care and maintenance of domestic animals. A hollow animal structure having a first concealed chamber is available for placement of plastic bags and various maintenance tools for use in servicing the relief station of a domestic pet. The plastic bags are used to receive pet waste such as cat litter. A second concealed chamber is accessible through a trap door for temporary placement of the pet waste. The device allows for more frequent maintenance of a pet's relief area by providing the necessary maintenance items to maintain the waste in a closed and sealed chamber where they can be disposed of at the convenience of the pet's owner.

U.S. Pat. No. 6,578,730 describes a dog feces collection bag dispenser and used bag receptacle unit for collecting animal feces comprises a container for holding and dispensing a roll of plastic film bags and a used bag disposal receptacle. A frame for attaching the unit upon a support surface holds the container above the receptacle. Bags are manually pulled out of the container and torn from the roll of bags and are used for collecting animal waste material, such as dog feces. The used bags are deposited in the waste bag receptacle which may be removed from the frame periodically for disposition of the used bags.

U.S. Pat. No. 6,227,149 describes a Sanitary refuse and animal dung collection valet comprising a sanitary, portable, light weight, and hand held and actuated refuse and waste collection device, and more particularly a telescopically adjustable, refuse and animal dung collection valet configured for convenient and sanitary collection of refuse and animal waste without the need for direct user contact with the refuse or animal dung and compatible for use with readily available disposal bags. The sanitary refuse and animal dung collection valet includes a collector assembly having two tubes pivotally connected in a lever or scissors arrangement. The user grips and actuates the handles of the valet on the upper end of the tubes to scoop the waste from the ground and into a refuse collection receptacle such as a disposable bag. The bag is supported at a lower end of the valet on a support frame connected to one of the tubes and which is opposingly positioned to cooperate with a pusher paddle connected to the lower end of the other tube. When the handles are moved together, the paddle scrapes the waste along in the direction of the open bag. The open end of the bag is folded over the paddle and the frame so that the waste never contacts any surface of the valet and only side of the bag. Once the waste has been scooped into the bag, the bag is removed from the valet paddle and frame for disposal.

U.S. Pat. No. 6,170,692 describes an animal waste bag dispenser and disposal unit comprising a mounting bracket, a container for holding bags, having a bucket and lid, and a receptacle. The container and receptacle are attached to the mounting bracket by nuts and bolts which extend through apertures positioned along the length of the mounting bracket. Bands wrapping around the mounting bracket through a plurality of notches enable the bracket to be attached to a pole or tree. These bands allow the height of the unit to be adjusted to a convenient level along the pole. The front side of the bucket has an opening through which bags contained inside can be retrieved. The bucket is covered by a lid having a lip which extends downward from the lid over the bucket. The lid prevents the natural elements, namely rain and snow, from seeping into the bucket; thus, the bags contained within the container remain dry and clean. The receptacle has a hollow body and top and bottom caps, thereby enabling the receptacle to be emptied when full.

These prior art devices do not provide effective solutions to the problem of odor. There is a need for methods and devices that permit a more sanitary and effective solution to the temporary storage of dog waste.

### SUMMARY OF THE INVENTION

One embodiment of the current invention is Curb Patrol™ which provides a safe, clean and even attractive solution to the problem of how to safely and hygienically remove animal feces from a yard, a neighborhood or wherever an animal relieves itself.

Some of the advantages of the product are that it encourages citizens to clean up after their dogs; it is more sanitary than using plastic bags from the supermarket; it is more attractive way to carry dog dropping during the animal's walk; the “doggie bags” or other disposal bags keep offensive smells contained; the system keeps bacteria and organisms from touching human hands; the system is a non-offensive, attractive way to store animal waste between trash pick ups; it assists citizens and towns in abiding by “dog curbing” laws; and the system is economical to run and the “waste bags” are inexpensive to use.

### DESCRIPTION OF FIGURES

These and other features, aspects, and advantages of the present invention will become better understood with regard to the following description, appended claims, and accompanying drawings where:

FIG. 1 is a schematic of a Curb Patrol™ unit.

FIG. 2 is a front view of a Waste Bag.

FIG. 3A is a perspective view of another embodiment of a closed receptacle and bag.

FIG. 3B is a perspective view of the receptacle of FIG. 3A opened to accept the bag.

FIG. 3C is a perspective view of the receptacle of FIG. 3A and a bag sealing mechanism.

FIG. 4 is a flow chart for a method of using the Curb Patrol™ unit.

FIG. 5 is a top view of disposable scoops.

### DETAILED DESCRIPTION OF EMBODIMENT—CURB PATROL™ ANIMAL WASTE RECEPTACLE

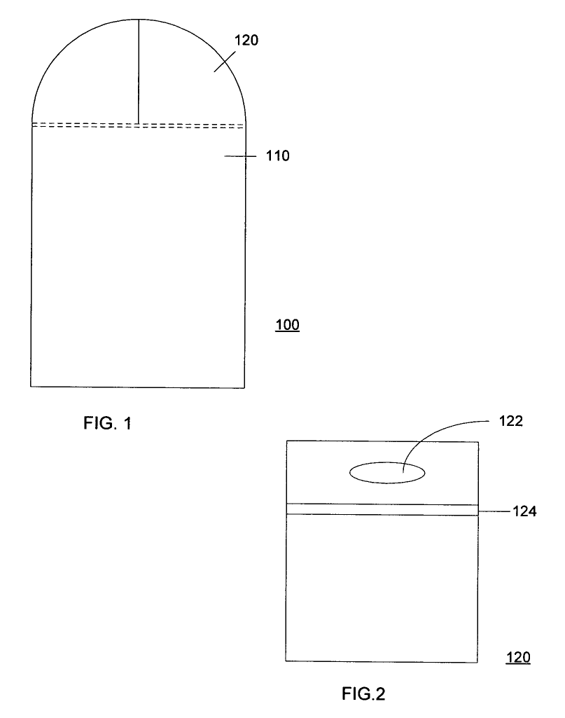

Referring to FIG. 1, the Curb Patrol™ unit comprises three parts: a plurality of plastic bags 120, a bag heat sealing mechanism 110, and a temporary storage receptacle 100. The bags may be odor containing plastic waste bags. In one embodiment, the waste bags are made of a high quality, thick polyethylene terepthalate plastic (PET).

Disposable Bags

Once the dog has concluded his business, a “waste bag” is used to scoop up the waste material using a small cardboard scoop contained in the bag. The bags preferably have cut out handles 122 to carry the excrement easily back to the Curb Patrol™ unit. The bag may be temporarily sealed with a zipper closure 124 at the top of the bag. The bag is then taken home and placed in the Curb Patrol™ unit for heat sealing and complete odor-proof closure of the bag. The waste bags and the waste container may come in a variety of prints and colors suitable for any dog owner's taste.

In one example, the device comes with a supply of “waste bags” and several disposable cardboard shovels to scoop up dog droppings.

Bag Sealing Mechanism

In this example, a heat-sealing mechanism is described. Other methods for sealing the waste bags include a zipper closure or snap closure on the bag which is typically used for a temporary closure in combination with a permanent sealing means; an adhesive close; a crimp seal; a jaw seal; a tape bag seal; and a vacuum seal.

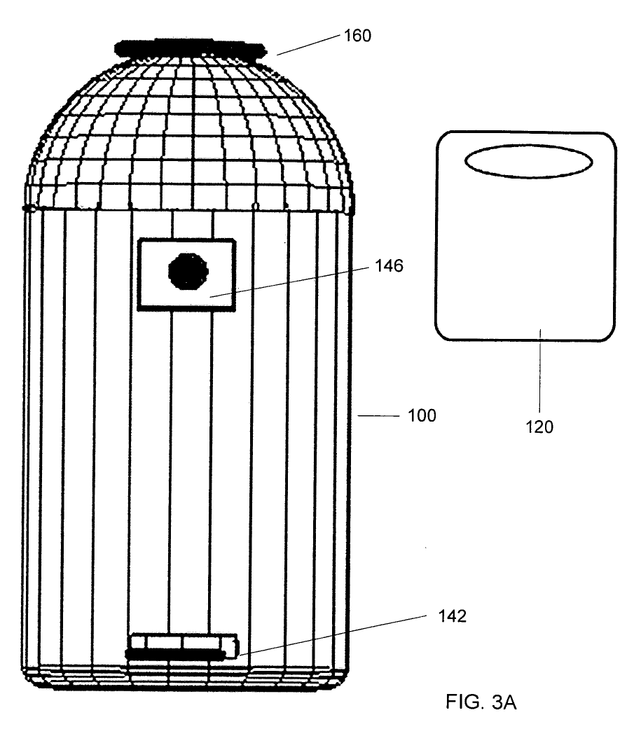

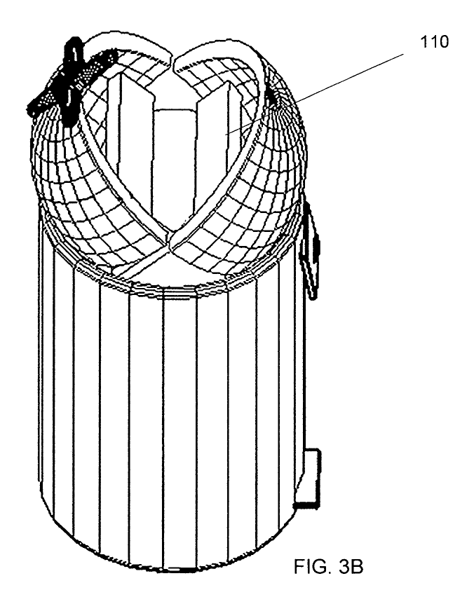

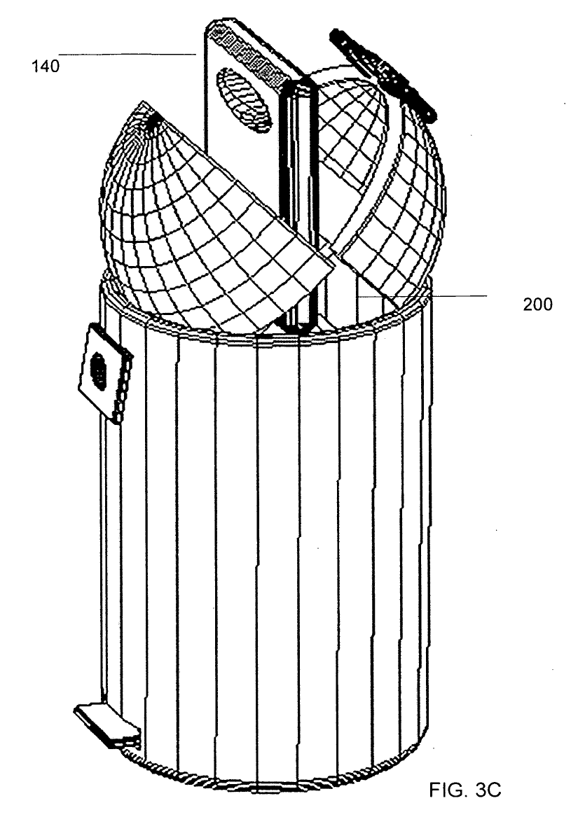

FIG. 3A is a perspective view of another embodiment of a closed receptacle 140 and bag 120. FIG. 3B is a perspective view of the receptacle of FIG. 3A opened to accept the bag. FIG. 3C is a perspective view of the receptacle of FIG. 3A and a bag sealing mechanism 200.

A receptacle unit 140 houses a heat sealing mechanism 110 which provides a seal for each bag after use.

In this example, the receptacle unit 140 houses a heat sealing unit 110. A foot pedal 142 opens the top of the receptacle unit and exposes the heat sealer. The “waste bag” is placed in the heat sealer by aligning the “waste bag” with a printed line, or other indicator, on the outside of the bag. A small button 146 on the side of the unit closes the heat sealer for about 2 seconds, and effectively seals the bag. At the end of the two seconds, the heat sealer automatically opens, dropping the sealed waste bag to the bottom of the receptacle. The unit is then closed by removing the foot from the foot pedal, and the top of the unit is secured shut with a childproof, wing nut type closure 160.

A plastic housing around the heat sealer protects hands and fingers from coming in contact with the sealing device. The locking mechanism locks the container and makes it childproof when not in use.

The device plugs into a standard 110 volt electrical outlet and requires little energy to operate. The device may also be converted for battery use or 220v for international use.

Examples of sealing devices include a Bosch—Model #HS-BII Heat Sealer; a Pack-Rite Poly-Jaw Sealer; an N-State Packaging—Model #SPB12-12 in. Impulse Bag Sealer; a U-Line—Model #H1069 Crimp Sealer; a Food-Saver Vac 1200 Vacuum Sealer; a Powerseal—Tape Bag Sealer; a Tile-Vac—Model #750 Vacuum Sealer; a Euro Sealer; and an Aspal PT-V Ultrasonic Crimp Sealer.

Receptacle Unit

The storage receptacle holds the sealed Waste Bags until trash pick up. Once the bag is completely closed and sealed, no more odors will escape the bag and the high quality plastic bag will not easily puncture or leak. The bag will not open without the use of a scissors.

In one embodiment the receptacle is a plastic container with a safety locking mechanism to keep top of container shut when not in operation.

In this example, the device is cylindrical shaped but can take on any shape, such as square, shaped like a fire hydrant or rectangular. The actual shape is immaterial to the operation of the device.

At the end of the week, the bottom of the container is unscrewed or otherwise detached and the waste bags are sent out with the weekly trash pickup.

In this embodiment, a heat sealing mechanism is used to isolate waste and store the soiled bags in a plastic container with a safety locking mechanism to keep top of container shut when not in operation.

Scoop

The device comes with a supply of “waste bags” that comes with a small cardboard shovel to scoop up dog droppings. FIG. 5 is a top view of one example of disposable scoops. Scoop 180 is shown as a flat device that can be folded to provide a simple cardboard, plastic or other rigid material scoop for picking up animal waste. For manufacturing purpose, a square is stamped and then die cut diagonally along the dotted line producing 2 scoops per square. Slotted scoop 190 may be used to pick up litter box urine clumps or cat excrement.

### Detailed Description of Embodiment—Curb Patrol™ Animal Waste Receptacle Method of Use

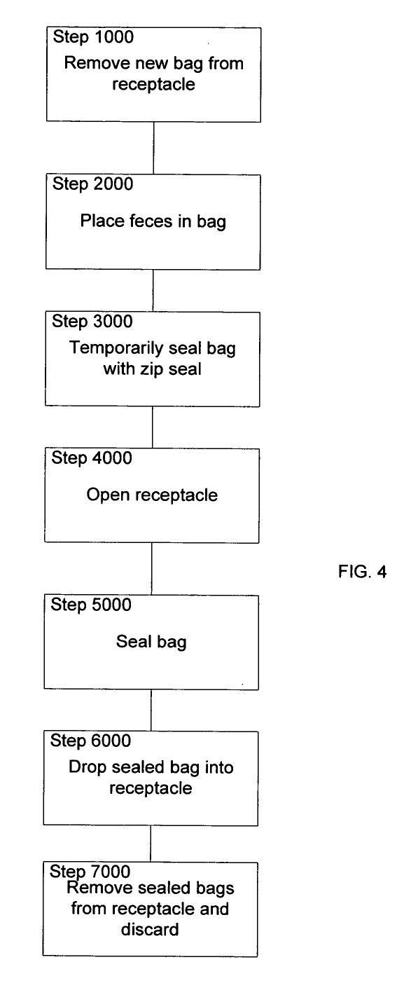

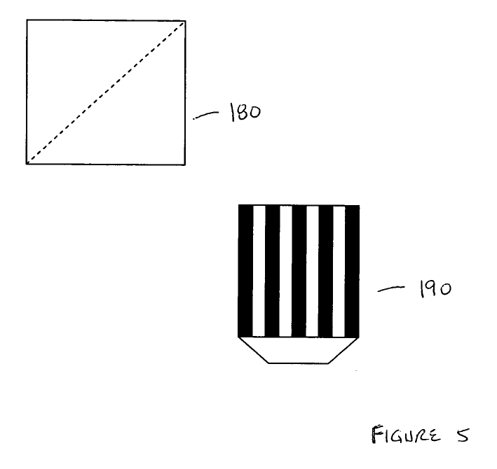

FIG. 4 is a flow chart for one method of using the Curb Patrol™ Animal Waste Receptacle.

At step 1000 a new disposal bag is removed from the receptacle. The bag is typically carried by a handle, rolled up in a hand, or placed in a pocket of the person walking a dog. A disposable scoop is contained in the bag for the pet owner's convenience and for sanitary pickup without having to touch the excrement.

At step 2000, the feces are collected in the bag. The feces may be collected by partially inverting the bag and using the bag as a glove, or by scooping the feces into the bag with the scoop.

At step 3000, the bag is temporarily sealed with a zipper closure. The scoop is typically inserted into the bag before this temporary sealing.

At step 4000, when the person arrives back at the receptacle, the receptacle is opened to expose the bag sealing mechanism, such as a heat sealing device.

At step 5000, the bag is sealed with the bag sealing mechanism.

At step 6000, the sealed bag is dropped into the receptacle.

At step 7000, the sealed bags are removed from the bottom of the receptacle and carried to a garbage can or other disposal point.

### Detailed Description of Embodiment—Method for Emptying the Curb Patrol™ Animal Waste Receptacle

In one example, a removable liner such as a rigid plastic liner is provided in the bottom of the receptacle so that the liner may be removed from the receptacle and taken to a garbage can where the bags may be emptied. The liner may then be re-inserted into the receptacle.

In another example, disposable paper or plastic bags may be provided in the bottom of the receptacle so that the entire bag and its contents of sealed doggie bags may be discarded.

In another example, there is no liner or bag in the bottom of the receptacle, and the sealed feces disposal bags are removed and discarded.

### Detailed Description of Embodiment—Decorative Receptacle and Bags

In one embodiment, the Curb Patrol unit uses a receptacle similar in size to a fire hydrant or 20 gallon trash container and is capable of holding up to 3 weeks of daily waste before it will require emptying. The receptacle is made of a high grade plastic material such as PTFE or metal that will not warp, stain or crack. It is easy to clean the outside or inside of the receptacle with a hose and hot soapy water. In this example, the receptacle measures approximately 10 inches high and 12″ diameter but it can be modified as desired.

In one embodiment, Pastel colored receptacles are provided along with matching disposable bags. In one embodiment, patterns or drawings such as paws or a pet's name are provided on the receptacle unit. The Unit can be manufactured in any color at the discretion of the manufacturer.

In one embodiment, a dog's name is engraved on the receptacle, and may be provided on the bags.

In one embodiment, scented disposables bags are provided with baking soda for additional odor control.

In one embodiment, a special scoop for picking up excrement is provided.

In one embodiment, an automatic reorder and restocking form for users is provided.

### Detailed Description of Embodiment—Litter Box and Other Feces

In other embodiments, the receptacle and disposal bags are sized for other pets including cats, hamsters, guinea pigs, or other animals. For example, the scoop and bags may be designed to remove feces and clumped litter from cat litter boxes.

What is claimed is:

1. A system for the temporary storage of animal feces, the system comprising
a plurality of plastic bags for collecting the animal feces;
a sealing device to provide an odor-free seal on the plastic bags; and
a storage receptacle for temporarily storing the sealed bags.

2. The system of claim 1 wherein
the plurality of plastic bags are constructed of an odor-resistant plastic.

3. The system of claim 1 wherein
the plurality of plastic bags are provided as a roll of bags.

4. The system of claim 1 wherein
the plurality of plastic bags are provided in a container or box.

5. The system of claim 1 wherein
the plurality of plastic bags are provided as individual bags.

6. The system of claim 1 further comprising
a plurality of disposable scoops for collecting feces in the plastic bags.

7. The system of claim 1 wherein
the sealing device is a heat sealing device.

8. A temporary storage receptacle for animal feces, the receptacle comprising
a storage area for a plurality of plastic bags for collecting the animal feces;
a sealing device to provide an odor-free heat seal on a plastic bag; and
a storage chamber for temporarily storing the sealed bags.

9. The temporary storage receptacle of claim 8 wherein
the sealing device is a heat sealing device.

10. The temporary storage receptacle of claim 8 further comprising
a foot pedal to open the receptacle; and
a locking mechanism.

11. The temporary storage receptacle of claim 8 wherein the storage chamber further comprises
a removable liner, such that the liner may be used to transport the stored heat sealed bags to a garbage collection location.

12. The temporary storage receptacle of claim 1 1 wherein the removable liner further comprises
at least one handle.

13. A method for the temporary storage device for domestic animal waste comprising
providing a temporary storage receptacle for animal feces, the receptacle comprising
a storage area for a plurality of plastic bags for collecting the animal feces,
a sealing device to provide an odor-free heat seal on a plastic bag, and
a storage chamber for temporarily storing the sealed bags;
removing a plastic bag from the temporary storage receptacle;
scooping animal waste into the bag;
sealing the bag; and
placing the sealed bag in the receptacle storage chamber.

14. The method of claim 13 further comprising
providing an odor-resistant plastic bag.

15. The method of claim 13 further comprising
providing a scoop with each plastic bag.

16. The method of claim 13 further comprising
providing a heat sealing device to provide an odor-free heat seal on a plastic bag.

17. The method of claim 16 wherein sealing the bag further comprises
sealing the bag with the heat sealing device.

18. The method of claim 13 wherein sealing the bag further comprises
sealing the bag at a first time with a zipper lock; and
sealing the bag at a second time with a heat seal.
